(19) United States
(12) Patent Application Publication
(10) Pub. No.: US 2025/0091529 A1
(43) Pub. Date: Mar. 20, 2025

(54) SHAPED PART AND METHOD FOR PRODUCING A SHAPED PART

(71) Applicant: Novem Car Interior Design GmbH, Vorbach (DE)

(72) Inventors: Daniel HOPF, Bayreuth (DE); Alexander MARTIN, Königstein (DE); Gabriel SCHABORAK, Bayreuth (DE)

(21) Appl. No.: 18/290,727

(22) PCT Filed: Jul. 20, 2022
(86) PCT No.: PCT/EP2022/070380

§ 371 Date: Jan. 19, 2024

(30) Foreign Application Priority Data
Jul. 21, 2021 (DE) 10 2021 118 912.8

(51) Int. Cl. B60R 13/02; B29C 45/14; B29L 31/30; B32B 3/26

(52) U.S. Cl. CPC B60R 13/02; B32B 3/266; B29C 45/14688; B29C 2793/0018; B29L 2031/3005; B32B 2451/00; B32B 2605/003; B60R 2013/0287

(57) ABSTRACT

The invention relates to a shaped part comprising a decorative layer having a front side designed as a visible side and a rear side opposite the front side, wherein the decorative layer is or comprises a decorative sheet, and a carrier arranged on the rear side of the decorative layer, wherein the decorative sheet has a grille at least in portions, wherein the grille is an integral component of the decorative sheet and is formed by a plurality of openings that extend from a front side of the decorative sheet to a rear side of the decorative sheet, wherein sound and/or air can be guided through the openings from the rear side of the decorative layer to the front side of the decorative layer and/or from the front side of the decorative layer to the rear side of the decorative layer.

The invention relates to a shaped part, in particular to a decorative and/or panel part designed as a shaped part for the vehicle interior, and to a method for producing a shaped part, in particular a shaped part according to the invention.

Numerous decorative and panel parts are installed in the vehicle interior, for example door panels, console panels, and instrument panels. The decorative and panel parts also include control buttons and their covers.

With such shaped parts, there is a need to create loudspeaker grilles, fan nozzles or microphone openings in the shaped part. Loudspeaker grilles, fan nozzles, and microphone openings are always designed as extra components for the vehicle interior. In some cases, loudspeaker grilles, fan nozzles, microphone openings are combined with shaped parts, but always as an extra component that has to be mounted and visually interrupts the shaped part surface.

The invention is based on the object of specifying a new shaped part and a new method for producing a shaped part, in particular a shaped part and a method for producing a shaped part, with which the functions of the loudspeaker grille, the fan nozzle and/or microphone openings are or are integrated into the shaped part surface.

This object is achieved in terms of the shaped part by the features of claim 1 and in terms of the method by the features of claim 9. Advantageous embodiments and further developments are provided in each of the dependent claims.

The shaped part according to the invention comprises a decorative layer having a front side designed as a visible side and a rear side opposite the front side, wherein the decorative layer is or comprises a decorative sheet, and a carrier arranged on the rear side of the decorative layer, wherein the decorative sheet has a grille at least in portions, wherein the grille is an integral component of the decorative sheet and is formed by a plurality of openings that extend, in particular in a straight line, from a front side of the decorative sheet to a rear side of the decorative sheet, wherein sound and/or air can be guided through the openings from the rear side of the decorative layer to the front side of the decorative layer and/or from the front side of the decorative layer to the rear side of the decorative layer.

Particularly preferably, the grille is not an extra component that has to be mounted to the decorative sheet or inserted into the decorative sheet.

In this connection, “arranged on the rear side of the decorative layer” is not intended to mean that the carrier must be attached directly to the rear side, but merely that the carrier is arranged on this side of the decorative layer and in particular is not arranged on the front side designed as a visible side. One or more intermediate layers, for example one or more sound-transmissive layers, can certainly be arranged between the carrier and the decorative layer.

A substantial advantage of the invention is that an additional carrier for mounting a loudspeaker can be dispensed with, since the connecting elements can be integrated directly into the shaped part carrier.

Furthermore, the required installation space for the integration of the loudspeaker grille or fan grille or microphone grille is also reduced. The overall appearance of the shaped part according to the invention also appears tidier. In addition, larger loudspeaker surfaces are possible.

Preferably, the decorative sheet is or comprises wood, preferably a wood veneer, and/or carbon and/or plastic and/or a foil and/or stone and/or a metal and/or ceramic and/or a textile, for example fabric, and/or a hybrid material.

The grille is preferably designed as a loudspeaker grille and/or microphone grille and/or ventilation grille.

According to a further development of the invention, the shaped part has at least one loudspeaker and/or a microphone and/or a fan, wherein the loudspeaker and/or the microphone and/or the fan, preferably in the region of the grille, is arranged on the rear side of the decorative layer and/or on or in the carrier, for example in a recess in the carrier.

It can be provided that the grille has a provided shape in a plane parallel to the front side of the decorative layer, wherein the provided shape is designed to be elliptical or round or angular or a symbol.

According to one embodiment of the invention, the decorative layer comprises a stabilizing layer, in particular made of nonwoven fabric, which is arranged on the rear side of the decorative layer, wherein the stabilizing layer is preferably glued to a rear side of the decorative sheet by means of a first adhesive layer, wherein the openings extend from the front side of the decorative layer through the stabilizing layer, and preferably the first adhesive layer, to a rear side of the stabilizing layer.

Furthermore, it can be provided that the decorative layer comprises a reinforcing layer, in particular made of metal, which is arranged on the rear side of the decorative sheet, wherein the reinforcing layer is preferably glued to the rear side of the decorative layer by means of a second adhesive layer, wherein the openings extend from the front side of the decorative sheet through the reinforcing layer, and preferably the second adhesive layer, to a rear side of the reinforcing layer.

According to a particularly preferred embodiment of the invention, the decorative layer comprises a reinforcing layer, in particular made of metal, which is arranged on the rear side of the stabilizing layer, wherein the reinforcing layer is preferably glued to a rear side of the stabilizing layer by means of a second adhesive layer, wherein the openings extend from the front side of the decorative layer through the stabilizing layer and the reinforcing layer, and preferably through the first adhesive layer and the second adhesive layer, to a rear side of the reinforcing layer.

A further development of the invention provides for a sound-transmissive layer, in particular made of felt and/or mesh, to be arranged on at least one portion, in particular in the region of the grille, the rear side of the decorative layer.

The invention also relates to a method for producing a shaped part, in particular the shaped part according to the invention, comprising a decorative layer with a front side designed as a visible side and a rear side opposite the front side, wherein the decorative layer is or comprises a decorative sheet, and a carrier arranged on the rear side of the decorative layer, wherein the decorative sheet has a grille at least in portions, wherein the grille is an integral component of the decorative sheet and is formed by a plurality of openings that extend, in particular in a straight line, from a front side of the decorative sheet to a rear side of the decorative sheet, wherein sound and/or air can be guided through the openings from the rear side of the decorative layer to the front side of the decorative layer and/or from the front side of the decorative layer to the rear side of the decorative layer.

The method according to the invention includes the following steps:
a) providing a decorative material for forming the decorative sheet,
b) forming the decorative layer at least with or by the decorative sheet,
c) forming a grille in the decorative sheet by introducing a plurality of openings into the decorative sheet, which extend, in particular in a straight line, from the front side of the decorative sheet to the rear side of the decorative sheet through the decorative sheet,
d) attaching the carrier to the rear side of the decorative layer.

According to a further development of the method, at least one loudspeaker and/or a microphone and/or a fan, preferably in the region of the grille, is arranged on the rear side of the decorative layer and/or on or in the carrier, for example in a recess in the carrier.

It can be provided that the openings are introduced into the decorative sheet in such a way that the grille forms a provided shape in a plane parallel to the front side of the decorative layer, wherein the provided shape is designed to be elliptical or round or angular or a symbol.

According to one embodiment of the method, it is provided that, after the decorative material has been provided to form the decorative sheet, a stabilizing layer, in particular made of a nonwoven, is arranged on the rear side of the decorative sheet in order to form the decorative layer, wherein the stabilizing layer is preferably glued to a rear side of the decorative sheet by means of a first adhesive layer.

It can be provided that the grille is subsequently formed by introducing the openings into the decorative sheet in such a way that the openings extend from the front side of the decorative sheet through the stabilizing layer, and preferably the first adhesive layer, to the rear side of the stabilizing layer.

Furthermore, it can be provided that after the decorative material has been provided to form the decorative sheet, a reinforcing layer, in particular made of metal, is arranged on the rear side of the decorative sheet in order to form the decorative layer, wherein the reinforcing layer is preferably glued to the rear side of the decorative sheet by means of a second adhesive layer.

It can be provided that the grille is subsequently formed by introducing the openings into the decorative sheet in such a way that the openings extend from the front side of the decorative sheet through the reinforcing layer, and preferably the second adhesive layer, to the rear side of the reinforcing layer.

According to a preferred embodiment of the method, after the stabilizing layer has been arranged on the rear side of the decorative sheet, a reinforcing layer, in particular made of metal, is arranged on the rear side of the stabilizing layer, wherein the reinforcing layer is preferably glued to the rear side of the stabilizing layer by means of a second adhesive layer.

It can be provided that the grille is subsequently formed by introducing the openings into the decorative sheet in such a way that the openings extend from the front side of the decorative layer through the stabilizing layer and the reinforcing layer, and preferably the first adhesive layer and the second adhesive layer, to the rear side of the reinforcing layer.

A hole pattern is preferably introduced into the reinforcing layer, in particular before the reinforcing layer is arranged on the rear side of the decorative sheet or on the rear side of the stabilizing layer, wherein the hole pattern corresponds to the grille to be provided in the decorative sheet.

Furthermore, after the reinforcing layer has been arranged, in particular on the rear side of the decorative sheet or the rear side of the stabilizing layer, the openings are preferably introduced through the hole pattern into the decorative sheet, and preferably the stabilizing layer, so that openings are created, which extend from the front side of the decorative layer through the decorative sheet and the reinforcing layer, and preferably the stabilizing layer, and in particular the first adhesive layer and the second adhesive layer, to the rear side of the reinforcing layer. Therefore, the holes of the hole pattern preferably form a portion of the finished openings.

According to one embodiment of the method, a sound-transmissive layer, in particular made of felt and/or mesh, is arranged at least on a portion of the rear side of the decorative layer, in particular in the region of the grille.

It can be provided that the carrier is injection-molded onto the rear side of the decorative layer by means of injection molding. Alternatively, it can be provided that the carrier, in particular by means of a third adhesive layer, is arranged, preferably glued, on the rear side of the decorative layer, wherein the carrier is preferably produced beforehand by means of injection molding.

For example, the openings and/or the hole pattern are formed by means of lasering and/or punching and/or etching.

It is preferably provided that the decorative layer is preformed, in particular three-dimensionally, prior to the attachment of the carrier.

Optionally, it can be provided that the edges and/or flanks of the openings, in particular on the front side of the decorative layer, are provided with a protective layer by means of the application of paint and/or by means of a paint layer.

It can be provided that the adhesion of one layer to the one further layer, for example of the carrier to the decorative layer, is carried out under pressure, preferably by pressing.

The invention is explained in more detail below also with regard to further features and advantages on the basis of the description of exemplary embodiments and with reference to the accompanying schematic drawing. In the drawings:

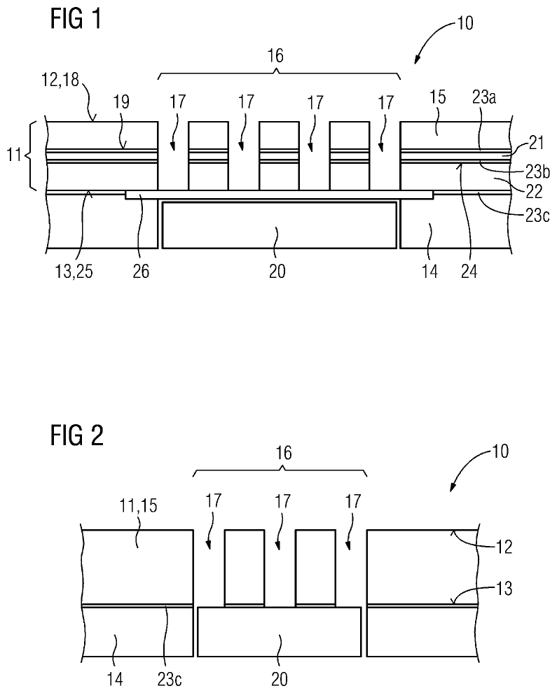

FIG. 1 shows a schematic sectional representation of a detail of a first exemplary embodiment of a shaped part according to the invention;

FIG. 2 shows a schematic sectional representation of a detail of a second exemplary embodiment of a shaped part according to the invention.

Corresponding parts and components are also identified with the same reference numbers in each of the various embodiments.

FIG. 1 shows a decorative and/or panel part according to the invention, designed as a shaped part 10, for the vehicle interior. The shaped part 10 comprises a decorative layer 11 with a front side 12 designed as a visible side and a rear side 13 opposite the front side 12, wherein the decorative layer 11 comprises a decorative sheet 15. The shaped part 10 further comprises a carrier 14 arranged on the rear side 13 of the decorative layer 11.

The decorative sheet 15 is, for example, a wood veneer and has in portions a grille 16, wherein the grille 16 is an integral component of the decorative sheet 15 and is formed by a plurality of openings 17 that extend in a straight line from a front side 18 of the decorative sheet 15 to a rear side 19 of the decorative sheet 15, wherein sound and/or air can be guided through the openings 17 from the rear side 13 of the decorative layer 11 to the front side 12 of the decorative layer 11 and/or from the front side 12 of the decorative layer 11 to the rear side 13 of the decorative layer 11.

The grille 16 is not an extra component that has to be mounted on the decorative sheet 15 or inserted into the decorative sheet 15. According to the exemplary embodiment of FIG. 1, the grille 16 is loudspeaker grille. In a plane parallel to the front side 12 of the decorative layer 11 (i.e., in a plan view of the front side 12), the grille has a provided shape. Loudspeaker grilles are typically designed to be round. However, the grille 16 can also have any other shape, for example it can be designed to be angular.

The shaped part 10 has a loudspeaker 20, wherein the loudspeaker 20 is arranged in a recess in the carrier 14 in the region of the grille 16 on the rear side 13 of the decorative layer.

In addition to the decorative sheet 15, the decorative layer 11 comprises a stabilizing layer 21 made of nonwoven and a reinforcing layer 22 made of metal. The stabilizing layer 21 is arranged on the rear side 19 of the decorative sheet 15, wherein the stabilizing layer 21 is glued to the rear side 19 of the decorative sheet 15 by means of a first adhesive layer 23a. The reinforcing layer 22 is arranged on the rear side 24 of the stabilizing layer 21, wherein the reinforcing layer 22 is glued to the rear side 24 of the stabilizing layer 21 by means of a second adhesive layer 23b. The openings 17 extend from the front side 12 of the decorative layer 11 through the decorative sheet 15, the stabilizing layer 21 and the reinforcing layer 22 and through the first adhesive layer 23a and the second adhesive layer 23b to the rear side 25 of the reinforcing layer 22 and thus through the entire decorative layer 11, so that sound and/or air can be guided from the rear side 13 of the decorative layer 11 to the front side 12 of the decorative layer 11, and vice versa.

Furthermore, a sound-transmissive layer 26 of felt or mesh is arranged on a portion of the rear side 13 of the decorative layer 11, in the region of the grille 16.

The carrier 14 is glued to the rear side of the decorative layer 11 by means of a third adhesive layer 23c. The sound-transmissive layer 26 forms in portions an intermediate layer between the carrier 14 and the decorative layer 11.

In the following, a method according to the invention for producing the previously described shaped part 10 according to the invention as shown in the exemplary embodiment according to FIG. 1 will be shown.

According to the method according to the invention, a decorative material for forming the decorative sheet 15 is initially provided according to a first method step a). The decorative material is a wood veneer, for example.

Subsequently, according to a step b), the decorative layer 11 is formed with the decorative sheet 15, wherein a stabilizing layer 21 made of nonwoven is arranged on the rear side 19 of the decorative sheet 15, wherein the stabilizing layer 21 is glued to the rear side 19 of the decorative sheet 15 by means of a first adhesive layer 23a. After the stabilizing layer 21 has been arranged on the rear side 19 of the decorative sheet 15, a reinforcing layer 22 made of metal is arranged on the rear side 24 of the stabilizing layer 21, wherein the reinforcing layer 22 is glued to the rear side 24 of the stabilizing layer 21 by means of a second adhesive layer 23b. In this way, the decorative layer 11 with the decorative sheet 15 and a stabilizing layer 21 and a reinforcing layer 22 are formed.

Before the reinforcing layer 22 is arranged on the rear side 24 of the stabilizing layer 21, a hole pattern is initially introduced into the reinforcing layer 22, wherein the hole pattern corresponds to the grille 16 to be provided in the decorative sheet 15. The hole pattern is formed by means of lasers, punching or etching.

Subsequently, according to a method step c), the grille 16 is formed in the decorative sheet 15 by introducing a plurality of openings 17 into the decorative sheet 15 that extend in a straight line from the front side 18 of the decorative sheet 15 to the rear side 19 of the decorative sheet 15 through the decorative sheet 15. The openings can be introduced into the decorative sheet 15 by means of lasers, punching or etching.

The openings 17 are introduced through the hole pattern in the reinforcing layer 22 into the decorative sheet 15 and the stabilizing layer 21, so that overall openings 17 are created, which extend from the front side 12 of the decorative layer 11 through the reinforcing layer 22 and the stabilizing layer 21 and the first adhesive layer 23a and the second adhesive layer 23b to the rear side 25 of the reinforcing layer 22, so that the openings 17 extend completely through the decorative layer 11.

The formed decorative layer 11 is subsequently preformed three-dimensionally, for example in a suitable tool.

A sound-transmissive layer 26 of felt or mesh is thereupon arranged in portions, in the region of the grille 16 on the rear side 13 of the decorative layer 11.

Subsequently, according to a step d), the carrier 14 is attached to the rear side 13 of the decorative layer 11. The carrier 14 is initially produced by means of injection molding and subsequently glued to the rear side 13 of the decorative layer 11 by means of a third adhesive layer 23c. Furthermore, a loudspeaker 20 is arranged in the region of the grille 16 in a recess in the carrier 14.

The edges or flanks of the openings 17 on the front side 12 of the decorative layer 11 are finally provided with a protective layer by means of applying paint.

FIG. 2 shows a further shaped part 10 according to the invention. The shaped part 10 comprises a decorative layer 11 with a front side 12 designed as a visible side and a rear side 13 opposite the front side 12. The decorative layer 11 is formed by a decorative sheet 15. The decorative sheet 15 is, for example, a wood veneer. The shaped part 10 further comprises a carrier 14 arranged on the rear side 13 of the decorative layer 11.

The decorative sheet 15 has in portions a grille 16, wherein the grille 16 is an integral component of the decorative sheet 15 and is formed by a plurality of openings 17 that extend in a straight line from a front side 18 of the decorative sheet 15 to a rear side 19 of the decorative sheet 15, wherein sound and/or air can be guided through the openings 17 from the rear side 13 of the decorative layer 11 to the front side 12 of the decorative layer 11 and/or from the front side 12 of the decorative layer 11 to the rear side 13 of the decorative layer 11. The grille 16 is not an extra component that has to be mounted on the decorative sheet 15 or inserted into the decorative sheet 15. The grille 16 is designed as a loudspeaker grille. The shaped part 10 further comprises a loudspeaker 20 that is arranged in a recess in the carrier 14 in the region of the grille 16 on the rear side 13 of the decorative layer 11.

In the following, a method according to the invention for producing the previously described shaped part 10 according to the invention as shown in the exemplary embodiment according to FIG. 1 will be shown.

According to the method according to the invention, a decorative material for forming the decorative sheet 15 is initially provided according to a first method step a). The decorative material is a wood veneer, for example.

The decorative layer 11 is subsequently formed by the decorative sheet 15 according to a step b).

According to a subsequent step c), the grille 16 is thereupon formed in the decorative sheet 15 by introducing a plurality of openings 17 into the decorative sheet 15, wherein the openings 17 extend in a straight line from the front side 18 of the decorative sheet 15 to the rear side 19 of the decorative sheet 15 through the decorative sheet 15. The openings 17 are formed by means of lasers.

According to a step d), the carrier 14 is then attached to the rear side 13 of the decorative layer 11. The carrier 14 is glued to the rear side 13 of the decorative layer 11 by means of an adhesive layer 23c and pressed therewith. The carrier 14 was previously produced by means of injection molding. Furthermore, a loudspeaker 20 is subsequently arranged in a recess in the carrier 14 in the region of the grille 16 on the rear side 13 of the decorative layer 11. The decorative layer 11 is three-dimensionally preformed prior to the attachment of the carrier 14.

### LIST OF REFERENCE SIGNS

10 Shaped part
11 Decorative layer
12 Front side (decorative layer)
13 Rear side (decorative layer)
14 Carrier
15 Decorative sheet
16 Grille
17 Opening
18 Front side (decorative sheet)
19 Rear side (decorative sheet)
20 Loudspeaker
21 Stabilizing layer
22 Reinforcing layer
23a First adhesive layer
23b First adhesive layer
23c First adhesive layer
24 Rear side (stabilization layer)
25 Rear side (reinforcement layer)
26 Sound-transmissive layer

1-20. (canceled)

21. A shaped part comprising:
a decorative layer having a front side designed as a visible side and a rear side opposite the front side, wherein the decorative layer is or comprises a decorative sheet, and
a carrier arranged on the rear side of the decorative layer,
wherein the decorative sheet has a grille at least in portions, wherein the grille is an integral component of the decorative sheet and is formed by a plurality of openings that extend from a front side of the decorative sheet to a rear side of the decorative sheet, wherein sound and/or air can be guided through the openings from the rear side of the decorative layer to the front side of the decorative layer and/or from the front side of the decorative layer to the rear side of the decorative layer.

22. The shaped part according to claim 21, wherein:
the grille is designed as a loudspeaker grille and/or microphone grille and/or ventilation grille.

23. The shaped part according to claim 21, wherein:
the shaped part has at least one loudspeaker and/or one microphone and/or one fan, wherein the loudspeaker and/or the microphone and/or the fan is arranged on the rear side of the decorative layer and/or on or in the carrier.

24. The shaped part according to claim 21, wherein:
the grille has a provided shape in a plane parallel to the front side of the decorative layer, wherein the provided shape is designed to be elliptical or round or angular or a symbol.

25. The shaped part according to claim 21, wherein:
the decorative layer comprises a stabilizing layer, which is arranged on the rear side of the decorative sheet, wherein the openings extend from the front side of the decorative layer through the stabilizing layer to a rear side of the stabilizing layer.

26. The shaped part according to claim 21, wherein:
the decorative layer comprises a reinforcing layer, which is arranged on the rear side of the decorative sheet, wherein the openings extend from the front side of the decorative layer through the reinforcing layer to a rear side of the reinforcing layer.

27. The shaped part according to claim 25, wherein:
the decorative layer comprises a reinforcing layer, which is arranged on the rear side of the stabilizing layer, wherein the openings extend from the front side of the decorative layer through the stabilizing layer and the reinforcing layer to a rear side of the reinforcing layer.

28. The shaped part according to claim 21, wherein:
a sound-transmissive layer is arranged at least on a portion of the rear side of the decorative layer.

29. A method for producing a shaped part, comprising:
a decorative layer having a front side designed as a visible side and a rear side opposite the front side, wherein the decorative layer is or comprises a decorative sheet, and
a carrier arranged on the rear side of the decorative layer,
wherein the decorative sheet has a grille at least in portions, wherein the grille is an integral component of the decorative sheet and is formed by a plurality of openings that extend from a front side of the decorative sheet to a rear side of the decorative sheet, wherein sound and/or air can be guided through the openings from the rear side of the decorative layer to the front side of the decorative layer and/or from the front side of the decorative layer to the rear side of the decorative layer,
the method comprising the steps of:
a) providing a decorative material for forming the decorative sheet,
b) forming the decorative layer at least with or by the decorative sheet,
c) forming a grille in the decorative sheet by introducing a plurality of openings into the decorative sheet, which extend from the front side of the decorative sheet to the rear side of the decorative sheet through the decorative sheet,
d) attaching the carrier to the rear side of the decorative layer.

30. The method according to claim 29, wherein:
at least one loudspeaker and/or one microphone and/or one fan is arranged on the rear side of the decorative layer and/or on or in the carrier.

31. The method according to claim 29, wherein:
the openings are introduced into the decorative sheet in such a way that the grille forms a provided shape in a plane parallel to the front side of the decorative layer, wherein the provided shape is designed to be elliptical or round or angular or a symbol.

32. The method according to claim 29, wherein:
after the decorative material has been provided to form the decorative sheet, a stabilizing layer is arranged on the rear side of the decorative sheet in order to form the decorative layer.

33. The method according to claim 29, wherein:
after the decorative material has been provided to form the decorative sheet, a reinforcing layer is arranged on the rear side of the decorative sheet in order to form the decorative layer.

34. The method according to claim 29, wherein:
after the stabilizing layer has been arranged on the rear side of the decorative sheet, a reinforcing layer is arranged on the rear side of the stabilizing layer.

35. The method according to claim 34, wherein:
a hole pattern is introduced into the reinforcing layer, wherein the hole pattern corresponds to the grille to be provided in the decorative sheet.

36. The method according to claim 35, wherein:
the hole pattern is introduced into the reinforcing layer before the reinforcing layer is arranged on the rear side of the decorative sheet or on the rear side of the stabilizing layer.

37. The method according to claim 35, wherein:
after the reinforcing layer has been arranged, the openings are introduced through the hole pattern into the decorative sheet, so that openings are created, which extend from the front side of the decorative layer through the decorative sheet and the reinforcing layer to the rear side of the reinforcing layer.

38. The method according to claim 29, wherein:
a sound-transmissive layer is arranged at least on a portion of the rear side of the decorative layer.

39. The method according to claim 29, wherein:
the carrier is injection-molded onto the rear side of the decorative layer by means of injection molding, or
the carrier is arranged on the rear side of the decorative layer.

40. The method according to claim 29, wherein:
the openings are formed by means of lasers and/or punching and/or etching.
